(19) United States
(12) Patent Application Publication
(10) Pub. No.: US 2012/0003371 A1
(43) Pub. Date: Jan. 5, 2012

(54) Acidification and Preservation of Food Products

(76) Inventors: Athula Ekanayake, Cincinnati, OH (US); Jeffrey John Kester, West Chester, OH (US)

(21) Appl. No.: 12/826,731

(22) Filed: Jun. 30, 2010

(51) Int. Cl. A23L 3/34

(52) U.S. Cl. 426/335; 426/532

(57) ABSTRACT

A process for acidifying and preserving a food product. The process can include providing a food product having an initial pH, acidifying the food product to a final pH to produce an acidified food product, treating the acidified food product with a preservative composition comprising a moisture sensitive isothiocyanate compound, wherein the acidifying and treating produce an acidified and preserved food product.

### FIELD

Embodiments of the present invention relate to the acidification and preservation of food products. More particularly, but not exclusively, embodiments of the present invention relate to acidification of food products by adding acids and antimicrobial agents to food products under particular conditions.

### BACKGROUND

Acids are used to decrease the pH of foods. By doing so, they can improve its microbial stability and impact its taste by imparting their own flavor and modifying the taste perception of other ingredients. By improving the food's microbial stability, the acids can be used as preservatives in acidification processes. More broadly, conventional food preservative processes, for example, canning, freezing, acidification, refrigeration, among others, typically involve multiple heat treatment steps and/or a combination of heat treatment with other negative processing steps that affect food quality and flavor. However, consumers are no longer willing to compromise the quality of foods that results from some of these negative processing steps. Accordingly, numerous solutions have been set forth to attempt to minimize the negative steps that affect food quality and flavor.

In acidification, to reach the desired pH level, manufacturers have the choice between various acids. Tradition, labeling, economics, stability, quality, and supply are some of the factors that may affect a manufacturer's choice of which of the various acids to use. Additionally, the degree of acidification performed can reduce the amount of downstream food preservative processes that may be utilized, but a higher degree of acidification can negatively impact the flavor and taste of the food.

Although some of prior attempts have improved some aspects of food quality, flavor, and taste, a need exists for additional further improvements.

Many reported instances exist in both the patent and scientific literature with respect to acidifying high pH foods to pH values less than 4.6 so that thermal processes of lesser intensity than those used to sterilize low acid canned foods can be used to process them. However, particularly when mixed acids are used to achieve these lower pH values, the order of addition has not been enunciated well. Typically, a mixture of acids is used without specifying the order of addition of the acids, including which acid is added first. It may be partly due to the pKₐ values for the ionizations of the commonly used organic acids being relatively close together.

Additionally, a current concern exists among public health officials that the level of sodium in the average diet is too high. Partly it is due to the high concentration of common salt in processed foods. Salt, like sugar, has the sensory ability to reduce the perception of sour taste of acidified foods. Food processors have used this approach to acidify foods to pH values less than 4.6 and cover up the resulting sour taste by the use of high amounts of salt. By the judicious use of mixed acids, particularly utilizing the order of addition effects, the sourness of acidified foods can be reduced, consequently reducing the salt concentration in processed food products.

As a third area of use of the mixed acids order of addition technology, an antimicrobial compound or system can be used in conjunction with these acidifying effects to reduce the microbial load in acidified foods, prior to thermal processing. This approach can enable the reduction of the intensity of thermal processes used to process such foods. This approach can be particularly useful because naturally occurring antimicrobials, such as white mustard essential oil, can be used in such an application. Today's consumers looking for flavorful, safe, and convenient foods will like the advantages that this combined approach will bring towards appealing to their tastes.

### SUMMARY

Embodiments of the present invention relate to the acidification and preservation of food products. More particularly, but not exclusively, embodiments of the present invention relate to acidification of food products by adding acids and antimicrobial agents to food products under particular conditions.

In one embodiment, a process for acidifying and preserving a food product is disclosed. In one embodiment, the process can comprise providing a food product having an initial pH; acidifying the food product to a final pH to produce an acidified food product; treating the acidified food product with a preservative composition that can comprise a moisture sensitive isothiocyanate compound; wherein the acidifying and treating produce an acidified and preserved food product. In one embodiment, the preservative composition can comprise white mustard essential oil that can comprise 4-hydroxybenzyl isothiocyanate. In one embodiment, the preservative composition can further comprise a hygroscopic carrier. In one embodiment, the preservative composition can be substantially free of sorbic acid, benzoic acid, and salts thereof.

In another embodiment, the acidifying can comprise adding a first acid to the food product so as to adjust the initial pH of the food product to an intermediate pH of the food product; adding a second acid to the food product so as to adjust the intermediate pH of the food product to a final pH of the food product; wherein an acidified food product having the final pH is produced. In one embodiment, the first acid can comprise gluconic acid and the second acid can comprise an acid selected from the group consisting of lactic acid, citric acid, malic acid, oxalic acid, acetic acid, propionic acid, butyric acid, tartaric acid, adipic acid, malonic acid, succinic acid, pimelic acid, suberic acid, azelaic acid, sebacic acid, glycine, and mixtures and combinations thereof.

In another embodiment, a process for acidifying and preserving a food product is disclosed. In one embodiment, the process can comprise providing a food product having an initial pH; acidifying the food product to a final pH to produce an acidified food product, wherein acidifying can comprise adding a first acid to the food product so as to adjust the initial pH of the food product to an intermediate pH of the food product; adding a second acid to the food product so as to adjust the intermediate pH of the food product to a final pH of the food product; treating the acidified food product with a preservative composition, wherein the preservative composition can comprise 4-hydroxybenzyl isothiocyanate and a hygroscopic carrier that can comprise maltodextrin; wherein the acidifying and treating produce an acidified and preserved food product.

In another embodiment, an acidified and preserved food product can be prepared. In one embodiment, the food product can be prepared by a process that can comprise providing a food product having an initial pH; acidifying the food product to a final pH to produce an acidified food product; treating the acidified food product with a preservative composition that can comprise a moisture sensitive isothiocyanate compound; wherein the acidifying and treating produce an acidified and preserved food product.

### BRIEF DESCRIPTION OF THE DRAWINGS

FIG. 1 is a flow diagram of one embodiment of a process disclosed herein.

### DETAILED DESCRIPTION

### I. Definitions

All percentages, ratios, and proportions used herein are by weight unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All lists of items, such as, for example, lists of ingredients, are intended to and should be interpreted as Markush groups. Thus, all lists can be read and interpreted as items “selected from the group consisting of” . . . list of items . . . “and combinations and mixtures thereof.”

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

The compositions and processes herein may comprise, consist essentially of, or consist of any of the features or embodiments as described herein.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As used herein, the articles including “the”, “a”, and “an”, when used in a claim or in the specification, are understood to mean one or more of what is claimed or described.

As used herein, the terms “include”, “includes”, and “including” are meant to be non-limiting.

As used herein, the term “plurality” means more than one.

As used herein, the term “antimicrobial effect” means that the product inhibits growth of, eliminates, and/or otherwise decreases the presence of microorganisms such as, for example, yeast, bacteria, mold, and/or fungus, preferably yeast and/or bacteria.

As used herein, the term “food product” means a composition that is intended to be ingested by an animal, including mammals, for nutritional purposes, whether eaten or drunk.

As used herein, the term “natural pH” means the pH of the food product without having been affected by acidification and thus the pH of the food product in its unaltered state.

As used herein, the term “open environment” means wherein the food product is not constrained to a pressure controlled environment during the acidification process, such as a hermetically sealed container.

### II. Embodiments of the Present Invention

Embodiments of the present invention relate to the acidification of food products. More particularly, but not exclusively, embodiments of the present invention relate to acidification of food products by adding particular acids to particular food products under particular conditions. Such conditions can include, but are not limited to, order of addition of the acids, open environment addition, pH of the food products, types of food products, types of acids, among other conditions.

Accordingly, a process for acidifying a food product is disclosed. The process can include providing a food product having an initial pH. A first acid can be added to the food product so as to adjust the initial pH of the food product to an intermediate pH of the food product. A second acid can then be added to the food product so as to adjust the intermediate pH of the food product to a final pH of the food product, which produces an acidified food product having the final pH. The addition of the first acid and the second acid can be sequential such that all of the first acid is added before the second acid is added. In one embodiment, the first acid can be gluconic acid.

In general, acidification can assist in the preservation of food products. Embodiments of the present invention relate to a process of acidifying food products under particular conditions. Food products as used herein can include, but are not limited to, solid food products, liquid food products, and semi-solid food products.

In one specific embodiment, it has been found that when gluconic acid is used as one part of the mixed acids used for acidification, using it as the first acid allows its maximum acidifying potential to be leveraged, thus maximizing the reduction in pH and without increasing the sourness.

Solid food product refers to an edible, ingestible composition that does not readily flow under the force of gravity at a temperature that is typical for the storage of that product. Examples of solid food products include, but are not limited to, fruits, vegetables, meats (such as, but not limited to, beef, pork, poultry, and fish), natural and processed cheeses, baked goods, snack foods, margarines, spreads, and gelled food compositions.

Embodiments of the present invention can also be utilized in fluid products that are intended to be blended, mixed, injected, or otherwise incorporated into a finished solid food product or applied to the surface of a solid food product. Non-limiting examples include marinades, brine solutions, tenderizing solutions, dressings, sauces, gravies, and the like that are intended to be added to solid food products, such as, but not limited to, meats, poultry, fish, and vegetables.

Liquid food product refers to an edible, ingestible composition that does readily flow under the force of gravity at a temperature that is typical for the storage of that product. Examples of liquid food products include, but are not limited to, drinks (such as, but not limited to, juice, juice drinks, tea, coffee, and cola), smoothies, sports drinks, and flavored waters.

Semi-solid food product refers to an edible, ingestible composition that is a mixture of a solid food product and a liquid food product. Examples of semi-solid food products include, but are not limited to, purees, fruit purees, vegetable purees, peeled and unpeeled tomatoes, which can be whole, diced, crushed, canned, and/or frozen, ravioli, beans, soups, vegetable soups, beef soups, chicken soups, any soups with or without vegetables, canned sausage products, wieners, among others.

Embodiments of the present invention provide acidification processes that can minimize the thermal exposure of the food products after acidification has occurred. Limiting thermal exposure can be advantageous to keeping intact flavor and taste to the end consumer. The minimization of other food preservative processes can also be achieved by way of embodiments of the present invention, such food preservative process including canning, freezing, acidification, refrigeration, among others. For example, in one aspect, embodiments of the present invention can mitigate or even eliminate the freezing of the food product that was previously completed to preserve the food product. Additionally, embodiments of the present invention can mitigate or even eliminate later thermal processes that are used to kill off microbes.

As described, acidification can assist in the preservation of food products. Accordingly, embodiments of the present invention relate to acidifying food products under particular conditions to assist in the preservation of food products. Food products as used herein can include, but are not limited to, solid food products, liquid food products, and semi-solid food products. Some specific embodiments relate to purees, in particular garlic purees, roasted red bell pepper purees, ginger purees, tomato purees, onion purees, mixtures such as food particles suspended in a continuous phase of low viscosity juice/sauce or thicker purees, and other mixtures.

Accordingly, a process for acidifying a food product is disclosed. The process can include providing a food product having an initial pH. A first acid can be added to the food product so as to adjust the initial pH of the food product to an intermediate pH of the food product. A second acid can then be added to the food product so as to adjust the intermediate pH of the food product to a final pH of the food product, which produces an acidified food product having the final pH. The addition of the first acid and the second acid can be sequential such that all of the first acid is added to the food product before the second acid begins to be added to the food product. In one embodiment, the first acid can be gluconic acid. In one embodiment, the second acid can comprise an acid selected from the group consisting of lactic acid, citric acid, malic acid, oxalic acid, acetic acid, propionic acid, butyric acid, tartaric acid, adipic acid, malonic acid, succinic acid, pimelic acid, suberic acid, azelaic acid, sebacic acid, glycine, and mixtures and combinations thereof. Of course, any organic acid can be used. Additional number of acids can also be added, such as third, fourth, fifth, sixth, etc, up until an unlimited number of acids.

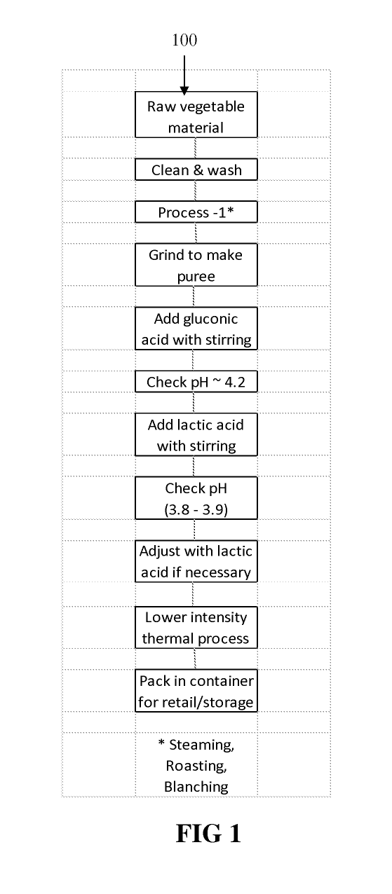

One specific embodiment of an acidification process is generally shown in FIG. 1 as process 100. A food product, such as a raw vegetable material, can be cleaned and washed. Any additional unit operations process step can then be performed. Such steps can include steaming, roasting, blanching, for example. The processed food product can then be subjected to a grinding step that grinds the food product into a puree having an initial pH. The puree can then be combined with acids. In a first step, a first acid, such as gluconic acid, can be added to the puree. The gluconic acid can be substantially mixed with the puree. In this specific embodiment, the puree when mixed with the first acid can result in the puree having an intermediate pH of about 4.2. Once the first acid has been completely added, the second acid can be added. The second acid can be lactic acid and can be added and substantially mixed with the puree. In this specific embodiment, the puree when mixed with the second acid can result in the puree having a final pH of about 3.8 to about 3.9. Further adjustment of the pH based on a specific target pH can then be performed such that the final pH of the puree matches that of the target pH. The adjustment of the pH can occur using the second acid, such as lactic acid. Once the pH of the puree reaches the target pH, the puree can be subjected to additional low intensity thermal processes. The puree can then be packed in a suitable container and shipped for retail or stored.

Specific embodiments of the invention are described herein. In one embodiment, a food product can be acidified as described herein to a final pH, or target pH, of about 3.80 from its natural pH of about 5.7. In one embodiment, the food product can be a puree. In one embodiment, the puree can be a garlic puree. In another embodiment, a food product can be acidified as described herein from its natural pH of about 4.7 to a final pH of about 3.80. In one embodiment, the puree can be a roasted red bell pepper puree. In these embodiments, the food product can be acidified such that the acidified food product is without a noticeable sour or increase in sour taste when compared to an unacidified food product or a food product acidified only with citric acid.

In embodiments herein, the food product can have a natural, or initial, pH of greater than about 4.0. In some embodiments, the food product can have a natural, or initial, pH of greater than about 4.5. In some embodiments, the food product can have a natural, or initial, pH of greater than about 5.0. In some embodiments, the food product can have a natural, or initial, pH of greater than about 5.5. In some embodiments, the food product can have a natural, or initial, pH of greater than about 6.0. In some embodiments, the food product can have a natural, or initial, pH of greater than about 6.5. In embodiments, the food product can have a natural, or initial, pH of about 4.0. In some embodiments, the food product can have a natural, or initial, pH of about 4.5. In some embodiments, the food product can have a natural, or initial, pH of about 5.0. In some embodiments, the food product can have a natural, or initial, pH of about 5.5. In some embodiments, the food product can have a natural, or initial, pH of about 6.0. In some embodiments, the food product can have a natural, or initial, pH of about 6.5.

In embodiments herein, the food product can be acidified as described herein to a final, or target, pH of less than about 4.0. In some embodiments herein, the food product can be acidified as described herein to a final, or target, pH of less than about 3.9. In some embodiments herein, the food product can be acidified as described herein to a final, or target, pH of less than about 3.8. In some embodiments herein, the food product can be acidified as described herein to a final, or target, pH of less than about 3.7. In some embodiments herein, the food product can be acidified as described herein to a final, or target, pH of less than about 3.6. In embodiments herein, the food product can be acidified as described herein to a final, or target, pH of about 4.0. In some embodiments herein, the food product can be acidified as described herein to a final, or target, pH of about 3.9. In some embodiments herein, the food product can be acidified as described herein to a final, or target, pH of about 3.8. In some embodiments herein, the food product can be acidified as described herein to a final, or target, pH of about 3.7. In some embodiments herein, the food product can be acidified as described herein to a final, or target, pH of about 3.6.

Any combination of natural pH of the food product and final pH of the acidified food product is within the scope of embodiments of the present invention.

In embodiments herein, the natural pH can correspond to the type of food product that is being acidified. Thus, in some embodiments, the natural pH can be a function of the type of food product that is being acidified as it is well known that food products have differing natural pHs. For example, a garlic puree can have a natural pH of about 5.7, while a roasted red bell pepper puree can have a natural pH of about 4.7. A tomato puree can have a natural pH of about 4.4, and a ginger puree can have a natural pH of about 6.6.

As described, the acidification of the food product can be performed by adding a first acid to adjust the initial pH of the food product to an intermediate pH of the food product. A second acid can then be added to the food product so as to adjust the intermediate pH of the food product to a final pH of the food product, which produces an acidified food product having the final pH. The addition of the first acid and the second acid can be sequential such that all of the first acid is added to the food product before the second acid begins to be added to the food product. In one embodiment, the first acid can be gluconic acid. In one embodiment, the second acid can be any acid selected from the group consisting of lactic acid, citric acid, malic acid, oxalic acid, acetic acid, propionic acid, butyric acid, tartaric acid, adipic acid, malonic acid, succinic acid, pimelic acid, suberic acid, azelaic acid, sebacic acid, glycine, and mixtures and combinations thereof. In some embodiments, the acid can be added as an aqueous solution. In some embodiments, the acid can be added in liquid pure form.

The first acid can be added to the food product to adjust the initial pH of the food product to an intermediate pH of the food product. The intermediate pH of the food product can vary depending on the initial pH of the food product and the desired final pH of the food product, both of which have been described herein. Accordingly, the intermediate pH of the food product can be between the initial pH of the food product and the desired final pH of the food product. In some embodiments, the intermediate pH is between about 6.5 and about 3.7. In embodiments herein, the food product can have an intermediate pH of greater than about 4.0. In some embodiments, the food product can have an intermediate pH of greater than about 4.5. In some embodiments, the food product can have an intermediate pH of greater than about 5.0. In some embodiments, the food product can have an intermediate pH of greater than about 5.5. In some embodiments, the food product can have an intermediate pH of greater than about 6.0. In some embodiments, the food product can have an intermediate pH of greater than about 6.5. In embodiments, the food product can have an intermediate of about 4.0. In some embodiments, the food product can have an intermediate pH of about 4.5. In some embodiments, the food product can have an intermediate pH of about 5.0. In some embodiments, the food product can have an intermediate pH of about 5.5. In some embodiments, the food product can have an intermediate pH of about 6.0. In some embodiments, the food product can have an intermediate pH of about 6.5. In embodiments herein, the food product can have an intermediate pH of less than about 4.0. In some embodiments herein, the food product can have an intermediate pH of less than about 3.9. In some embodiments herein, the food product can have an intermediate pH of less than about 3.8. In some embodiments herein, the food product can have an intermediate pH of less than about 3.7. In some embodiments herein, the food product can have an intermediate pH of about 3.9. In some embodiments herein, the food product can have an intermediate pH of about 3.8. In some embodiments herein, the food product can be acidified have an intermediate of about 3.7. In some embodiments, the intermediate pH can be in a range anywhere between 3.7 and 6.5, including fractions thereof.

A second acid can then be added to the food product so as to adjust the intermediate pH of the food product to a final pH of the food product, which produces an acidified food product having the final pH. The final pH can be as described herein.

In one embodiment, the addition of the first acid and the second acid can be sequential such that all of the first acid is added to the food product before the second acid begins to be added to the food product. In one embodiment, the first acid can be added to the food product and stirred well to ensure substantially uniform mixing. When the pH measurement of the intermediate pH is substantially stable, the second acid can be added to reach the target pH. The second acid can be added to the food product and stirred well to ensure substantially uniform mixing. In one embodiment, the first acid can be gluconic acid. In one embodiment, the second acid can be any acid selected from the group consisting of lactic acid, citric acid, malic acid, oxalic acid, acetic acid, propionic acid, butyric acid, tartaric acid, adipic acid, malonic acid, succinic acid, pimelic acid, suberic acid, azelaic acid, sebacic acid, glycine, and mixtures and combinations thereof.

As described, in one embodiment, gluconic acid can be selected as an acid added to the food product. In one embodiment, gluconic acid can be selected as the first acid added to the food product. Gluconic acid is an organic compound with molecular formula C₆H₁₂O₇ and condensed structural formula HOCH₂C(CHOH)₄COOH. The chemical structure of gluconic acid consists of a six-carbon chain with five hydroxyl groups terminating in a carboxylic acid group. In aqueous solution, gluconic acid exists in equilibrium with the cyclic ester Glucono delta lactone. In aqueous solution at delicately acidic pH, gluconic acid forms the gluconate ion. The salts of gluconic acid are known as “gluconates”. Gluconic acid, gluconate salts, and gluconate esters occur widely in nature because such species arise from the oxidation of glucose. Gluconic acid occurs naturally in fruit, honey, kombucha tea, and wine. As a food additive, it is an acidity regulator.

In one embodiment, following the addition to the food product of the first acid, such as gluconic acid, a second acid can be added to the food product. The second acid can be different from the first acid and can be any of the edible acids listed herein. In one specific embodiment, the second acid can be lactic acid.

As described, in one embodiment, lactic acid can be selected as an acid added to the food product. In one embodiment, lactic acid can be added as the second acid. In one embodiment, lactic acid can be added after gluconic acid is added. Lactic acid is a natural organic acid found in blood and other biological fluids. For commercial preparation, carbohydrate sources are subjected to fermentation by homolactic organisms such as Lactobacillus delbrueckii, L. bulgaricus, and L. leichmanii. As the classification implies, these organisms over-produce lactic acid as their sole fermentation product and after suitable purification steps such as advanced filtration methods to remove the organisms and other impurities, food grade lactic acid is produced.

Both gluconic and lactic acids are relatively mild tasting when diluted to the same level and tasted against other commonly available organic acids such as citric, malic, and oxalic acids and also have relatively mild odor compared to organic acids such as acetic, propionic, and butyric acids.

As described, additional conditions of the acidification can be controlled. In one embodiment, the acids can be added as aqueous solutions, in liquid or solid form. In some embodiments, the acids can be added at about 1M (1 Molar). Thus, in some embodiments, dilute acids such as 1.0 Molar solutions of acids in water are used. Acid solutions can be added in small portions and, after the pH measurement has stabilized with mixing, another portion of the acid solution can be added. When the target pH is reached, the acidified food product can be stirred, and the pH measurement confirmed. The acidification can then repeated with the direct undiluted acids being added in sequence to the food product with stirring. Measurement of the final pH confirms the actual amounts to be added in scaling up the experiment. In other embodiments, the acid can be added in other physical forms, such as powder, tablets, in mixtures with one or more carriers. Optional ingredients that can be included include sweeteners, salt, spices, condiments, natural and artificial flavorants, natural fiber, natural colorants, and other botanicals and extracts.

In another embodiment, a preservative composition can be used. The preservative composition can be an additional antimicrobial agent, compound, or system. One embodiment includes a moisture sensitive isothiocyanate compounds, which can include white mustard essential oil (WMEO) that comprises 4-hydroxybenzyl isothiocyanate (4-HBITC). It can be used to treat the acidified food product just prior to thermal treatment. Such embodiments specific to those describing moisture sensitive isothiocyanate compounds, and particularly WMEO, are described and incorporated by reference in U.S. Pat. No. 7,658,961 ('961 patent), assigned to The Procter & Gamble Company. Accordingly, in one embodiment, a food product acidified according to embodiments of the present invention described herein can be treated with 4-HBITC as described in the '961 patent. Thus, the food product can be acidified and then preserved as described in the '961 patent. In one embodiment, the preservative process can comprise providing the food product, adding to the food product a preservative composition comprising a moisture-sensitive isothiocyanate compound, and, within about 2 hours of adding the preservative composition to the food product, maintaining the temperature of the food product at a temperature not more than about 10° C. for at least about 12 hours. The specific preservative composition can be those as described in the '961 patent. Specifically, the preservative composition for use with the food product can comprise a moisture sensitive isothiocyanate compound, such as WMEO, and a hygroscopic carrier, wherein the composition is substantially free of sorbic acid, benzoic acid, and salts thereof.

The preservative composition can comprise a moisture-sensitive isothiocyanate compound (i.e., a compound bearing a —N═C═S moiety), such as, for example, the compound 4-hydroxybenzyl isothiocyanate, which is found in white mustard essential oil. Although any moisture-sensitive isothiocyanate can be used, the use of 4-hydroxybenzyl isothiocyanate is one particular compound. Regardless of the moisture-sensitive isothiocyanate employed, the present inventors have discovered that relatively low levels of the compound produce the desired antimicrobial effect in the present compositions and processes. In this regard, the isothiocyanate compound can be used in the preservative composition in an amount of from about 0.0025% to about 10%, or from about 0.005% to about 8%, or from about 0.01% to about 6%, or from about 0.1% to about 4%, by total weight of the composition. Any moisture-sensitive isothiocyanate compound bearing a —N═C═S moiety may be utilized in the present invention. Preferably, the isothiocyanate compound utilized in the present compositions has the structure R—N═C═S, wherein R is the 4-hydroxybenzyl or para-hydroxybenzyl moiety. This structure is commonly known as 4-hydroxybenzyl isothiocyanate or p-hydroxybenzyl isothiocyanate and may be synthetically obtained or alternatively naturally obtained from, for example, white mustard. Thus, in one embodiment, the constituent comprising the moisture-sensitive isothiocyanate compound can be an essential oil, natural component of an essential oil, or synthetic component of an essential oil (all as described in more detail hereafter) of the white or yellow mustard family (Sinapis alba or Brassica alba). Alternatively, the constituent comprising the moisture-sensitive isothiocyanate compound can be an essential oil, natural component of an essential oil, or synthetic component of an essential oil of any other family of plants which may produce a moisture-sensitive isothiocyanate compound. The essential oil can originate from a glucosinolate compound that is capable of producing an isothiocyanate compound (for example, through the catalytic hydrolysis of one or more glucosinolates by the enzyme myrosinase) wherein the precursor and enzyme containing plant tissue is homogenized, ground, crushed, pressed, or otherwise damaged. The essential oil derived from a Brassica family plant is obtained using procedures that are commonly known in the art. The essential oil itself, which contains one or more moisture-sensitive isothiocyanate compounds, preferably 4-hydroxybenzyl isothiocyanate, can then be utilized in the compositions and processes of the present invention.

There are numerous methods by which to dilute the moisture-sensitive isothiocyanate. For example, the isothiocyanate or the essential oil comprising the isothiocyanate can be dissolved, dispersed, or otherwise uniformly blended in a liquid hygroscopic carrier. Alternatively, the isothiocyanate or the essential oil comprising the isothiocyanate can be triturated with, plated onto, or otherwise intimately mixed with the solid particles of a powdered or granular hygroscopic carrier. Trituration is a process in which the isothiocyanate or the essential oil comprising the isothiocyanate and the hygroscopic powder or granular material are intimately mixed by pulverizing and/or comminuting thoroughly by rubbing or grinding. Plating of the isothiocyanate or the essential oil comprising the isothiocyanate onto the solid particles of a powdered or granular hygroscopic carrier refers to the process of coating the surface of such particles with a film or coating of the isothiocyanate or essential oil.

Any number of hygroscopic materials can be used. Suitable liquid hygroscopic materials for use as carriers include, but are not limited to, glycerin, polyethylene glycol, and propylene glycol. Suitable powdered or granular solid hygroscopic materials for use as carriers include, but are not limited to, polysaccharides (including maltodextrins, starches, and microcrystalline cellulose), oligosaccharides, sugars (including glucose, fructose, sucrose, maltose, and lactose), sugar alcohols (including mannitol, maltitol, erythritol, and sorbitol), salt, silicon dioxide (including precipitated and fumed silicas), and anti-caking agents and/or flow agents (including sodium silicoaluminate, calcium silicate, magnesium silicate, tricalcium phosphate, and magnesium carbonate). Particular carriers are maltodextrin and glycerin. The type of hygroscopic carrier used can depend on the ultimate application for the preservative composition. For instance, for many uses the carrier can be one of the powdered or granular solid materials, in particular maltodextrin, because of the ease of handling and shipping of the preservative composition. However, certain instances can exist in which a liquid preservative composition may be used because of its capability to be pumped or injected and/or because of its flow properties that may be critical for effective coating of the surfaces of solid food products. For example, use of glycerin as the hygroscopic can be effective when the preservative composition is blended into a ground beef product, in which the capability of the preservative composition to flow and uniformly coat the individual ground beef pieces may be beneficial.

The preservative compositions can comprise from about 90% to about 99.9%, by weight, of the hygroscopic carrier. Typically, the compositions can comprise from about 92% to about 99.9%, more typically from about 94% to about 99.9%, and even more typically from about 96% to about 99.9% by weight, of the hygroscopic carrier.

As described, the food products as disclosed herein can be treated with the preservative compositions described herein. In this regard, the moisture-sensitive isothiocyanate compound, such as 4-hydroxybenzyl isothiocyanate, can be present in an amount of from about 0.001% to about 0.06%, by weight, of the food product. More typically, the moisture sensitive isothiocyanate compound can be present in an amount of from about 0.003% to about 0.05%, even more typically from about 0.005% to about 0.04%, by weight, of the food product.

A variety of methods exist by which to add the isothiocyanate preservative composition to the food product, including, but not limited to, blending or otherwise mixing into a food matrix (e.g. ground beef) or preparing a liquid solution or dispersion comprising the isothiocyanate preservative composition (e.g. wash solution, brine solution, tenderizing solution, or marinade) into which a solid food product (such as a fruit, vegetable, or cut of meat, poultry, or fish) can be dipped or immersed to apply the preservative to the surface. Alternatively, a liquid solution or dispersion comprising the isothiocyanate preservative composition (e.g. brine solution, tenderizing solution, or marinade) can be sprayed, brushed, or otherwise coated onto the surface of the solid food product (such as, for example, a beef or poultry carcass), or it can be incorporated into the interior of the solid food product by pressure injection or vacuum tumbling. Pressure injection and vacuum tumbling are additional methods for incorporating the isothiocyanate preservative composition into intact cuts of meat, such as beef, pork, poultry, and fish. The isothiocyanate preservative compositions may also be incorporated into the materials used in the packaging of food products, which because of the intimate contact between the package material and the food product, can allow for the transfer of the preservative composition to the surface of the food product. A non-limiting example of such packaging material includes the absorbent pads placed under cuts of meat, such as poultry, that are intended for retail distribution.

The foregoing preservative process and preservative compositions can be used with any of the food products as described herein but particularly is useful with solid food products. Non-limiting examples of solid food products include, but are not limited to, fruits, vegetables, meats (such as beef, pork, poultry, and fish), natural and processed cheeses, baked goods, snack foods, margarines, spreads, and gelled food compositions. The preservative compositions described in the present invention may also be utilized in fluid products that are intended to be blended, mixed, injected, or otherwise incorporated into a finished solid food product, or applied to the surface of a solid food product. Examples include marinades, brine solutions, tenderizing solutions, dressings, sauces, gravies and the like that are intended to be added to solid food products, such as meats, poultry, fish, and vegetables.

Moreover, the present inventors have discovered that the residence time of the moisture-sensitive isothiocyanate compound, in one embodiment the 4-hydroxybenzyl isothiocyanate, can be extended by first adding the isothiocyanate preservative composition to the food product by any means discussed above, and then maintaining the temperature of the food product at not more than about 10° C., preferably not more than about 7.5° C., and more preferably not more than about 5° C. As a result of storing the solid food product at reduced temperature, the rate of degradation (i.e. hydrolysis) of the moisture-sensitive isothiocyanate can be reduced. Consequently, the residence time or life time of the active isothiocyanate antimicrobial compound is prolonged and the resultant antimicrobial efficacy is enhanced.

If the aforementioned liquid solution or dispersion comprising the isothiocyanate preservative composition is utilized to add the preservative to a food product (e.g. wash solution, brine solution, tenderizing solution, or marinade), the solution or dispersion can be maintained at a low temperature in order to minimize degradation of the moisture-sensitive isothiocyanate. In one embodiment, the solution or dispersion can be maintained at a temperature lower than about 10° C., or lower than about 7.5° C., or lower than about 5° C. Furthermore, the liquid solution or dispersion comprising the isothiocyanate preservative composition can have a pH between about pH 2 to 5, or between pH 3 to 4.5, in order to minimize the rate of degradation of the moisture-sensitive isothiocyanate. The liquid solution or dispersion may optionally contain an added surface active agent or emulsifier to improve spreadability and achieve a uniform coverage of the solution or dispersion onto a solid food product surface.

The food product need not necessarily be exposed to low temperatures immediately after adding the isothiocyanate preservative composition, however, in some embodiments, no more than about 2 hours, or no more than about 1 hour, or no more than about 30 minutes, can be permitted to elapse before exposing the food product to the low temperature. In one embodiment, the food product can be immediately exposed to low temperature after addition of the isothiocyanate preservative composition. Once exposed, the temperature of the food product can be maintained at this low level for at least about 12 hours, or at least about 24 hours, or at least about 72 hours, or at least about 120 hours, in order to prolong the residence time of the moisture-sensitive isothiocyanate compound in or on the food product.

Based on this description of the processes and preservative compositions related to white mustard essential oil, it has strong antimicrobial properties against bacteria, yeasts, and molds and can be used as an adjuvant in combination with mixed acids to reduce the microbial load in a food product just prior to thermal processing. In this manner, the thermal process intensity can be reduced to provide lethal conditions sufficient to provide food stability. For example, canned tomato sauce acidified to pH 4.2 with citric acid only requires a thermal process providing a can center temperature of about 85° C. for about 10 minutes. If a mixture of gluconic and lactic acids can be used as the acidulants, the pH can be further reduced to about 3.8 without increasing sourness, thus decreasing the thermal process intensity to 75° C. for 8 minutes. Additionally, if WMEO is used as an antimicrobial substance prior to thermal processing, the thermal process intensity can be reduced 65-70° C. for 7 minutes. This approach can produce a far superior canned tomato product.

Similarly, canned tomatoes, including tomatoes that are whole or even diced, can be rendered commercially sterile by subjecting cans with about 70% solid tomatoes and about 30% topping juice (flavored or unflavored) to a process schedule in atmospheric retorts. For example, diced tomatoes at pH equal to or less than about 4.40 can in one embodiment require an equivalent lethality of F15/215° F. for about 0.50 minutes or greater. Typically, at a pH equal to or less than about 4.40, a retort process time is about 25 minutes for a 300×407 can containing 14.5 oz net weight. This process time can be achieved when the retort temperature is 210° F., and the initial food temperature is 100° F. (z-value=15° F. and reference temperature=215° F.). Thermal processes could be shorter or longer depending on rotational speed, dice-to-liquid ratio, package size, package type, specific ingredients used, thickness of the liquid (continuous phase), type of agitation during retorting (still cook, end over end rotation, axi-symmetric rotation), aseptic processing applications, among other factors. Through pH reduction and/or incorporation of WMEO, both as described herein, the retorted process for solid packed tomatoes could be reduced by reducing retort temperature or process time. Additionally, the retorted process for solid packed tomatoes could be easily converted to milder hot-fill-hold processes similar to those mentioned above.

Other preservative compositions can be used similarly as WMEO described herein. These preservative compositions include those as described in U.S. Pat. Nos. 6,132,787; 6,136,356; and 6,376,005. Other preservative compositions that can be used include bacteriocins. Bacteriocins can include Nisalpin®, which is the tradename for nisin A and is manufactured by Danisco; DURAFresh™, which is the tradename for a natural freshness prolonging product manufactured by Kerry Group; monoglycerides; and polyphosphates, such as SHMP.

In one embodiment, the acidification can be performed in an open environment. An open environment can comprise ambient temperature and pressure, such as between about 68° F. and about 77° F. and between about 14.7 psi. Additionally, an open environment can comprise wherein the acidification does not place under controlled containers, such as those described in US 2004/0156960. Thus, in one embodiment, the acidification food product as described herein is not performed in sealed containers such that food product is not separated from the open environment. In one embodiment, the acidification of the food product occurs in an open environment such that no appreciable changes in the environment's temperature and/or pressure take place.

The amount of acid that can be added to the food product varies with the type of food product as can be expected. Some food products are highly buffered by nature and thus require more acid to change their pH than other foods that are less buffered. Buffers in natural foods may come from various sources such as simple cations and anions, free amino acids and peptides, and by soluble and insoluble proteins and can depend on the source of the natural food product resulting in varying buffer strength. For example, roasted red bell pepper puree can in one embodiment use about 0.9%, by total weight of the food product, added lactic acid to bring about the pH change to the target pH as disclosed herein, while garlic and ginger purees can in one embodiment use about 1.3-2.0%, by total weight of the food product, added acid to bring about the pH change to the target pH as disclosed herein. Thus, in one embodiment, the food product can comprise from about 0.75% to about 1.05% added acid. In other embodiments, the food product can comprise from about 1.15% to about 2.15% added acid.

The timing of addition of the acids can also vary. In one embodiment, the acids can be added at any point in the processing operation after the raw food material has been washed. Typically, the acids would be added after the food has been pureed and before thermal processing. Other unit operation such as roasting for example can in one embodiment be performed prior to the acid addition step to maximize the flavor generation effect of that unit operation.

Other optional ingredients such as flavorants, food fiber, salt or other spices, and condiments or botanicals or extracts can be added at this point just prior to thermal processing.

As described, in some embodiments, the minimization of other food preservative processes can also be achieved by way of embodiments of the present invention, such food preservative process including canning, freezing, acidification, refrigeration, among others. For example, in one aspect, embodiments of the present invention can mitigate or even eliminate the freezing of the food product that was previously completed to preserve the food product. Additionally, embodiments of the present invention can mitigate or even eliminate later thermal processes that are used to kill off microbes. However, it is noted that in some embodiments, some of these additional preservative process can be performed in addition to the acidification as described herein. For example, in one embodiment, thermal treatment, refrigeration, freezing, packing, etc. can be performed to the acidified food product. In one embodiment, the acidified is not frozen after acidification. In one embodiment, thermal treatment of the acidified food product can be performed. Thermal treatment can be performed to heat the food product to about 185° F. such that microbes are killed. The thermal treatment can be performed for a specified time period, such as for about 5 to about 10 minutes. Additionally, refrigeration of the acidified food product can be performed. Aseptically packaging of the acidifed food product can be performed as well.

Packaging can take a variety of forms, such as polythene lined steel drums and pails, tubs, and other rigid plastic containers. It can also be done in flexible plastic containers, such as pouches and totes. Glass packaging particularly of retail products can also be used.

Acidified and gently processed foods can be stored refrigerated or if thermally processed to provide a lethal treatment can be stored on a grocery store shelf at ambient temperature.

Because of the increased barrier provided to the food material to prevent the growth of spoilage organisms, food products that are usually stored frozen can be stored at refrigerated temperatures after being acidified according to embodiments of the present invention. Frozen storage can be cost prohibitive, and high cost materials are usually only frozen stored because of their inherent instability. Thawing frozen materials, particularly large containers, can take up much time, and, because of the non-uniformity of the thawing step, various parts of the frozen food product can be exposed to various temperature profiles resulting in slightly different but noticeable flavor and other sensory differences. Refrigeration, on the other hand, does not freeze the food product solid, and so it can much easier to use by a food products manufacturer. It is also generally more cost effective and can result in an overall lower cost and high quality food product.

### III. Examples

### Example 1

Roasted red bell pepper was acidified with lactic acid followed by gluconic acid as follows and as shown in Table 1 below. Approximately 285 grams of roasted red bell pepper in the form of puree was provided at a pH of 5.011. Approximately 15 grams of evaporated cane juice (ECJ), also called natural sugar, was then added to the roasted red bell pepper puree. This addition of ECJ decreased the pH of the puree to 4.966. Then, 1M lactic acid was added stepwise as follows: 1.00 ml, resulting in the pH of the puree to decrease to 4.878; 1.00 ml, resulting in the pH of the puree to decrease to 4.795; 1.00 ml, resulting in the pH of the puree to decrease to 4.732; 5.00 ml, resulting in the pH of the puree to decrease to 4.500; and, finally another 1.00 ml, resulting in the pH of the puree to decrease to 4.423. In sum, 9.00 mL of 1M lactic acid was added, and the pH of the puree decreased from 4.966 to 4.423.

Next, 1M gluconic acid was added stepwise to the puree as follows: 1.00 ml, resulting in the pH of the puree to decrease to 4.383; 5.00 ml, resulting in the pH of the puree to decrease to 4.213; 5.00 ml, resulting in the pH of the puree to decrease to 4.076; 2.50 ml, resulting in the pH of the puree to decrease to 4.017; 2.50 ml, resulting in the pH of the puree to decrease to 3.967; 1 ml, resulting in the pH of the puree to decrease to 3.936; 1.00 ml, resulting in the pH of the puree to decrease to 3.917; 1.00 ml, resulting in the pH of the puree to decrease to 3.896; 2.50 ml, resulting in the pH of the puree to decrease to 3.849; 1.00 ml, resulting in the pH of the puree to decrease to 3.834; 1.00 ml, resulting in the pH of the puree to decrease to 3.816; 0.50 ml, resulting in the pH of the puree to decrease to 3.810; and, finally 0.50 ml, resulting in the pH of the puree to decrease to 3.803. In sum, 24.50 mL of 1M gluconic acid was added, and the pH of the puree decreased from 4.423 to 3.803.

In summary, 9.00 mL of 1M lactic acid was added to roasted red bell pepper puree to decrease the pH from 4.966 to 4.423. Then, 24.50 mL of 1M gluconic acid was added to the roasted red bell pepper puree to decrease the pH from 4.423 to 3.803.

TABLE 1

| Total mL | | Total | mLs 1M | |
|---|---|---|---|---|
| 1M | mLs 1M | mL | Glc | |
| Lactic | Lactic added | 1M Glc | added | pH |
| 0.00 | 0.00 | 0.00 | 0.00 | pH = 5.011 |
| ECJ 15 g added | | | | pH = 4.966 |
| | 1.00 | | | pH = 4.878 |
| 2.00 | 1.00 | | | pH = 4.795 |
| 3.00 | 1.00 | | | pH = 4.732 |
| 8.00 | 5.00 | | | pH = 4.500 |
| 9.00 | 1.00 | | | pH = 4.423 |
| | | | 1.00 | pH = 4.383 |
| | | 6.00 | 5.00 | pH = 4.213 |
| | | 11.00 | 5.00 | pH = 4.076 |
| | | 13.50 | 2.50 | pH = 4.017 |
| | | 16.00 | 2.50 | pH = 3.967 |
| | | 17.00 | 1.00 | pH = 3.936 |
| | | 18.00 | 1.00 | pH = 3.917 |
| | | 19.00 | 1.00 | pH = 3.896 |
| | | 21.50 | 2.50 | pH = 3.849 |
| | | 22.50 | 1.00 | pH = 3.834 |
| | | 23.50 | 1.00 | pH = 3.816 |
| | | 24.00 | 0.50 | pH = 3.810 |
| | | 24.50 | 0.50 | pH = 3.803 |

The resulting acidified roasted red bell pepper puree did not have any sour notes but had enhanced flavor presentation and enhanced green notes indicating freshness. A slight reduction of overall flavor was also noted. These perceptions are as compared unacidified puree as well as acidified puree using only citric acid.

### Example 2

Roasted red bell pepper puree was acidified with gluconic acid followed by lactic acid as follows and as shown in Table 2 below. Approximately 285 grams of roasted red bell pepper in the form of puree was provided at a pH of 4.979. Approximately 15 grams of evaporated cane juice (ECJ), also called natural sugar, was then added to the roasted red bell pepper puree. This addition of ECJ decreased the pH of the puree to 4.956. Then, 1M gluconic acid was added stepwise as follows: 5.00 ml, resulting in the pH of the puree to decrease to 4.640; 2.50 ml, resulting in the pH of the puree to decrease to 4.519; and, finally another 2.50 ml, resulting in the pH of the puree to decrease to 4.404. In sum, 10.00 mL of 1M gluconic acid was added, and the pH of the puree decreased from 4.956 to 4.404.

Next, 1M lactic acid was added stepwise to the puree as follows: 5.00 ml, resulting in the pH of the puree to decrease to 4.205; 5.00 ml, resulting in the pH of the puree to decrease to 4.051; 2.50 ml, resulting in the pH of the puree to decrease to 3.993; 1.00 ml, resulting in the pH of the puree to decrease to 3.974; 1.00 ml, resulting in the pH of the puree to decrease to 3.949; 1.00 ml, resulting in the pH of the puree to decrease to 3.922; 2.50 ml, resulting in the pH of the puree to decrease to 3.869; 1.00 ml, resulting in the pH of the puree to decrease to 3.853; 1.00 ml, resulting in the pH of the puree to decrease to 3.837; 1.00 ml, resulting in the pH of the puree to decrease to 3.820; and, finally another 1.00 ml, resulting in the pH of the puree to decrease to 3.804. In sum, 22.00 mL of 1M lactic acid was added, and the pH of the puree decreased from 4.404 to 3.804.

In summary, 10.00 mL of 1M gluconic acid was added to roasted red bell pepper puree to decrease the pH from 4.956 to 4.404. Then, 22.00 mL of 1M lactic acid was added to the roasted red bell pepper puree to decrease the pH from 4.404 to 3.804.

TABLE 2

| Total mL | | Total | mLs 1M | |
|---|---|---|---|---|
| 1M | mLs 1M | mL | Glc | |
| Lactic | Lactic added | 1M Glc | added | pH |
| 0 | 0 | 0 | 0 | pH = 4.979 |
| ECJ 15 g added | | | | pH = 4.956 |
| | | 5 | 5 | pH = 4.640 |
| | | 7.5 | 2.5 | pH = 4.519 |
| | | 10 | 2.5 | pH = 4.404 |
| 5 | 5 | | 0 | pH = 4.205 |
| 10 | 5 | | | pH = 4.051 |
| 12.5 | 2.5 | | | pH = 3.993 |
| 13.5 | 1 | | | pH = 3.974 |
| 14.5 | 1 | | | pH = 3.949 |
| 15.5 | 1 | | | pH = 3.922 |
| 18 | 2.5 | | | pH = 3.869 |
| 19 | 1 | | | pH = 3.853 |
| 20 | 1 | | | pH = 3.837 |
| 21 | 1 | | | pH = 3.820 |
| 22 | 1 | | | pH = 3.804 |
| 22 | | 10 | | |

The resulting acidified roasted red bell pepper puree did not have any noticeable sour notes although the pH was 3.804. No noticeable reductions in flavor or any off-notes were observed. Green notes were enhanced compared to an unacidified control sample indicating a higher degree of freshness. These perceptions are as compared unacidified puree as well as acidified puree using only citric acid.

### Example 3

Garlic bulbs are harvested from the field and are first dry cleaned to remove most of the adhering soil. This cleaning is followed by a washing step where the outer parchment like white envelope material and residual root is removed to reveal the garlic cloves, which are covered by involucral leaf skins. Next, the cleaned garlic cloves are passed through a rotating perforated tunnel where they are exposed to live steam with a typical surface temperature of about 70-72° C. The steamed garlic bulbs are then cooled by a water spray which also removes some more of the leaf skins. The cooled bulbs are then chopped in a mill to provide a puree. The puree is then screened to ensure correct particle size and collect in a mixing tank equipped with paddle mixer. Gluconic acid is added first by means of a pump and the garlic puree mixed well to ensure homogeneity. Lactic acid is then added to reach the target pH of 3.8. After mixing for a further 5-10 minutes, the acidified garlic puree is placed in 5 gallon pails and stored refrigerated at 4-5° C.

### Example 4

Roasted red bell pepper puree is acidified and stored refrigerated. Red bell peppers are first cleaned and split to remove the seeds. The fresh red bell peppers are subject to roasting by tumbling on a rotating surface and cooled immediately thereafter. A scrubbing step then removes the outer peel and the peeled roasted red bell peppers are pureed and screened to remove any large particles. Gluconic acid solution (50%) is first added to the puree to reach an intermediate pH of about 4.2-4.1. This step is followed by lactic acid addition to final pH of 3.75-3.85. The acidified roasted red bell pepper puree is mixed well to ensure homogeneity and stored in 5 gallon pails under refrigerated conditions at about 4-5° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for acidifying and preserving a food product, comprising:
a) providing a food product having an initial pH;
b) acidifying the food product to a final pH to produce an acidified food product;
c) treating the acidified food product with a preservative composition comprising a moisture sensitive isothiocyanate compound;
wherein the acidifying and treating produce an acidified and preserved food product.

2. The process of claim 1 and wherein the preservative composition comprises white mustard essential oil comprising 4-hydroxybenzyl isothiocyanate.

3. The process of claim 2 and wherein the preservative composition further comprises a hygroscopic carrier.

4. The process of claim 3 and wherein the preservative composition is substantially free of sorbic acid, benzoic acid, and salts thereof.

5. The process of claim 2 and wherein the 4-hydroxybenzyl isothiocyanate is present in the preservative composition in an amount of from about 0.0025% to about 10%, by weight.

6. The process of claim 3 and wherein the hygroscopic carrier is a liquid and wherein the essential oil is uniformly blended in the hygroscopic carrier.

7. The process of claim 3 and wherein the hygroscopic carrier is granular and wherein the essential oil is intimately mixed with the hygroscopic carrier.

8. The process of claim 3 and wherein the hygroscopic carrier comprises maltodextrin.

9. The process of claim 3 and wherein the preservative composition comprises from about 90% to about 99.9%, by weight, hygroscopic carrier.

10. The process of claim 2 and wherein the 4-hydroxybenzyl isothiocyanate is present in an amount of from about 0.001% to about 0.06%, by weight, of the acidified food product.

11. The process of claim 1 and wherein within about 2 hours of adding the preservative composition to the food product, the temperature of the food product is maintained at a temperature not more than about 10° C. for at least about 12 hours.

12. The process of claim 1 and wherein the treating occurs prior to any thermal treatment of the acidified food product.

13. The process of claim 1 and wherein the acidifying step comprises:
b) adding a first acid to the food product so as to adjust the initial pH of the food product to an intermediate pH of the food product;
c) adding a second acid to the food product so as to adjust the intermediate pH of the food product to a final pH of the food product;
wherein an acidified food product having the final pH is produced.

14. The process of claim 13 and wherein the first acid comprises gluconic acid and the second acid comprises an acid selected from the group consisting of lactic acid, citric acid, malic acid, oxalic acid, acetic acid, propionic acid, butyric acid, tartaric acid, adipic acid, malonic acid, succinic acid, pimelic acid, suberic acid, azelaic acid, sebacic acid, glycine, and mixtures and combinations thereof.

15. The process of claim 1 and wherein the initial pH of the food product is greater than about 4.0.

16. The process of claim 1 and wherein the final pH of the food product is less than about 3.9.

17. The process of claim 1 and wherein the food product comprises a food product selected from the group of solid food products, liquid food products, and semi-solid food products.

18. The process of claim 1 and wherein the food product comprises a puree.

19. A process for acidifying and preserving a food product, comprising:
a) providing a food product having an initial pH;
b) acidifying the food product to a final pH to produce an acidified food product, wherein acidifying comprises:
i) adding a first acid to the food product so as to adjust the initial pH of the food product to an intermediate pH of the food product;
ii) adding a second acid to the food product so as to adjust the intermediate pH of the food product to a final pH of the food product;
c) treating the acidified food product with a preservative composition, wherein the preservative composition comprises 4-hydroxybenzyl isothiocyanate and a hygroscopic carrier comprising maltodextrin;
wherein the acidifying and treating produce an acidified and preserved food product.

20. An acidified and preserved food product prepared by a process comprising:
a) providing a food product having an initial pH;
b) acidifying the food product to a final pH to produce an acidified food product;
c) treating the acidified food product with a preservative composition comprising a moisture sensitive isothiocyanate compound;
wherein the acidifying and treating produce an acidified and preserved food product.
